(19) United States
(12) Patent Application Publication
(10) Pub. No.: US 2026/0316535 A1
(43) Pub. Date: Oct. 15, 2026

(54) CARGO COVER AND VEHICLE INCLUDING SAME

(71) Applicants: Kia Corporation, Seoul (KR); Hyundai Motor Company, Seoul (KR); Seoul National University R&DB Foundation, Seoul (KR)

(72) Inventors: Kyeong Jun Lim, Hwaseong-si (KR); Gook Hyun Jeon, Hwaseong-si (KR); Moo Seok Kwak, Hwaseong-si (KR); Yeong Hee Lee, Hwaseong-si (KR); Jae Seung Lee, Hwaseong-si (KR); Kyoung Taek Kwak, Hwaseong-si (KR); Sang-Gyeun Ahn, Seattle, WA (US); Junseo Kim, Seoul (KR); Changwoo Ha, Seoul (KR); Jinkyu Yang, Seoul (KR)

(21) Appl. No.: 19/312,979

(22) Filed: Aug. 28, 2025

(30) Foreign Application Priority Data
Apr. 11, 2025 (KR) 10-2025-0047659

(51) Int. Cl. B60J 7/14

(52) U.S. Cl. CPC B60J 7/141

(57) ABSTRACT

A cargo cover can include a hinge fixing portion disposed on both sides of a truck bed of a vehicle in a width direction, a guide rail disposed on both sides of the truck bed in the width direction and extending in a length direction of the truck bed, and a cover portion, wherein both sides of the cover portion in the width direction are rotatably and detachably coupled to the hinge fixing portion, and configured such that when the cover portion slides along the guide rail, the cover portion is separated from the hinge fixing portion and is hinged.

### CROSS-REFERENCE TO RELATED APPLICATIONS

This application claims benefit of priority to Korean Patent Application No. 10-2025-0047659 filed on Apr. 11, 2025 in the Korean Intellectual Property Office, the disclosure of which is incorporated herein by reference in its entirety.

### TECHNICAL FIELD

The present disclosure relates to a cargo cover and a vehicle including the same.

### BACKGROUND

A vehicle loading space may be provided in open form for loading and transporting cargo, but a cover may be used thereabove to protect the cargo from external environmental factors. In particular, in a vehicle such as a pickup truck, a truck bed is exposed externally, so various cover structures are being developed for the protection thereof.

A tonneau cover is widely used as a cover for a truck bed of a vehicle. A tonneau cover serves to cover the vehicle loading space and protect the contents, and is designed to have a lightweight structure, which has the advantage of minimizing fuel consumption of the vehicle. The tonneau cover has a panel-shaped structure covering a top opening of the truck bed of the vehicle.

Another cover for the truck bed is an overland rack. The overland rack is designed to allow additional loads to be loaded higher than a height of the truck bed of the truck, thereby having the advantage of expanding the loading space.

### SUMMARY

An embodiment of the present disclosure can provide a cargo cover that can be converted to various structures and a vehicle including the same.

According to an embodiment of the present disclosure, a cargo cover may include: a hinge fixing portion provided on both sides of a truck bed of a vehicle in a width direction; a guide rail provided on both sides of the truck bed in the width direction and extending in a length direction; a guide bracket slidably provided on the guide rail; and a cover portion, wherein both sides of the cover portion in the width direction are rotatably and detachably coupled to the hinge fixing portion, and when the cover portion is connected to the guide bracket and slides along the guide rail, the cover portion can be separated from the hinge fixing portion and can be hinged.

### BRIEF DESCRIPTION OF THE DRAWINGS

The above and other features and advantages of example embodiments of the present disclosure can be understood from the following detailed description, taken in conjunction with the accompanying drawings, in which:

FIG. 1 is a perspective view illustrating a cargo cover according to an embodiment of the present disclosure coupled to a truck bed of a vehicle in a first mode;

FIG. 2 is a perspective view illustrating an intermediate state in which a cargo cover according to an embodiment of the present disclosure is being converted to a second mode;

FIG. 3 is a perspective view illustrating a state in which a cargo cover according to an embodiment of the present disclosure is converted to a second mode;

FIG. 4 is a perspective view illustrating an intermediate state in which a cargo cover according to an embodiment of the present disclosure is being converted to a third mode;

FIG. 5 is a perspective view illustrating a state in which a cargo cover according to an embodiment of the present disclosure is converted to a third mode;

FIG. 6 is an exploded perspective view of a cargo cover according to an embodiment of the present disclosure;

FIG. 7 is a front view of a cargo cover according to an embodiment of the present disclosure;

FIG. 8 is a perspective view of a side panel portion according to an embodiment of the present disclosure;

FIG. 9 is an inner side view of a side panel portion in a width direction according to an embodiment of the present disclosure;

FIG. 10 is an outer side view of a side panel portion in a width direction according to an embodiment of the present disclosure;

FIG. 11 is an enlarged perspective view of part A of FIG. 3;

FIG. 12 is an enlarged front view of part B of FIG. 7;

FIG. 13 is an enlarged perspective view of part C of FIG. 1; and

FIG. 14A is a perspective view of a second mode portion of a cargo cover according to an embodiment of the present disclosure; and

FIG. 14B is a perspective view of a first mode portion of a cargo cover according to an embodiment of the present disclosure.

### DETAILED DESCRIPTION OF ILLUSTRATIVE EMBODIMENTS

Because the present disclosure may have various changes and may have various example embodiments of the present disclosure, specific example embodiments may be illustrated in the drawings and described in detail. However, this is not intended to necessarily limit the present disclosure to such specific example embodiments, and the present disclosure can be understood to include all modifications, equivalents, and substitutes included in the spirit and technical scopes of the present disclosure.

Terms such as “first”, “second”, and the like, may be used to describe various elements, but the elements are not necessarily limited by such terms. Such terms may be used merely for distinguishing one component from another. For example, without departing from the scopes of the present disclosure, a first component may be referred to as a second component, and similarly, a second component may also be referred to as a first component. The term “and/or” may include a combination of a plurality of related listed items or any of the plurality of related listed items.

Terms used in the present application may be only used to describe specific example embodiments, and are not necessarily intended to limit the present disclosure. The singular expression may include the plural expression, unless the context clearly dictates otherwise. In the present application, it can be understood that terms such as “include,” “comprise,” or “have” are intended to designate that features, numerals, steps, operations, components, parts, or combination thereof described in the specification exists, but does not preclude the existence or addition of numbers, steps, operations, components, parts, or combinations thereof for one or more other features.

Unless defined otherwise, terms used herein, including technical or scientific terms, can have same meanings as that which can commonly understood by one of ordinary skill in the art to which the present disclosure belongs. Terms such as those defined in a commonly used dictionary can be interpreted as having a meaning consistent with a meaning in the context of the related art.

In the explanation below, the terms “front,” “rear,” “upper,” “lower,” “above,” “below,” etc., can be used in relation to direction and can be described based on the illustration in the drawing.

Hereinafter, with reference to the attached drawings, example embodiments of the present disclosure will be described in more detail.

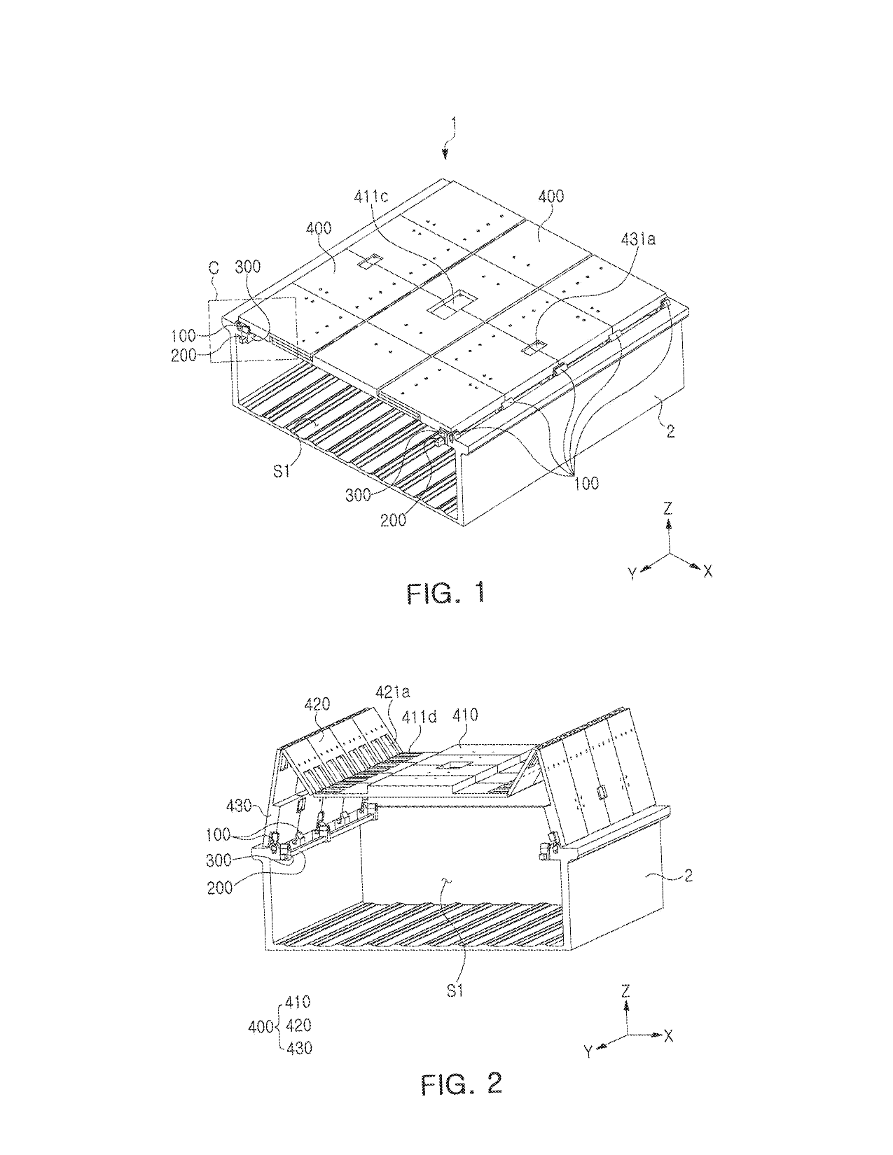

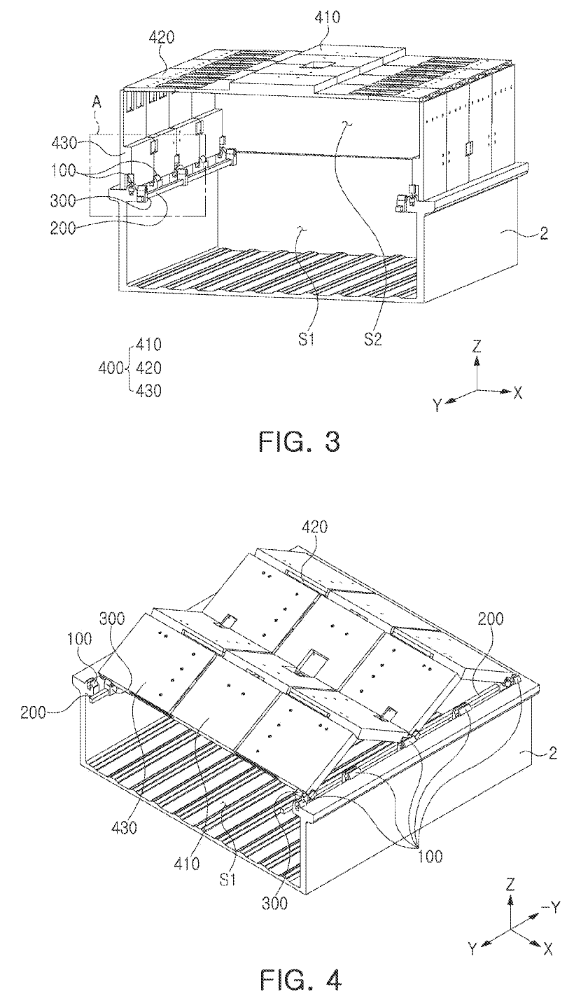

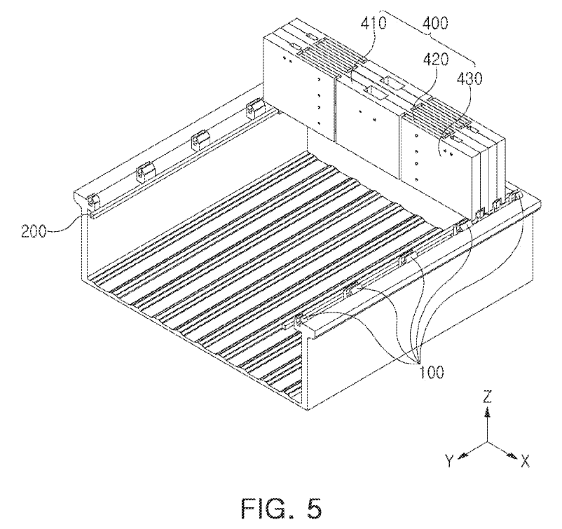

FIG. 1 is a perspective view illustrating a cargo cover according to an embodiment of the present disclosure coupled to a truck bed of a vehicle in a first mode. FIG. 2 is a perspective view illustrating an intermediate state in which a cargo cover according to an embodiment of the present disclosure is being converted to a second mode. FIG. 3 is a perspective view illustrating a state in which a cargo cover according to an embodiment of the present disclosure is converted to a second mode. FIG. 4 is a perspective view illustrating an intermediate state in which a cargo cover according to an embodiment of the present disclosure is being converted to a third mode. FIG. 5 is a perspective view illustrating a state in which a cargo cover according to an embodiment of the present disclosure is converted to a third mode.

Referring to FIGS. 1-5, a vehicle according to an embodiment of the present disclosure may include a truck bed 2 and a cargo cover 1 coupled to the truck bed. The vehicle may refer to various vehicles including the truck bed 2. As an example, the vehicle may be a pickup truck provided with a truck bed 2 at the rear side. However, the type of a vehicle is not limited as long as it is a vehicle provided with a truck bed 2 with an open top, for example. In other words, the cargo cover 1 according to an embodiment of the present disclosure can be installed on the truck bed 2 of the vehicle and can be a member for opening and closing the truck bed 2, which may be applied regardless of the type of a vehicle.

The cargo cover 1 may be coupled to the truck bed 2. The cargo cover 1 may open and close the truck bed 2, and/or expand a loading space S1 of the truck bed 2. The cargo cover 1 may be converted to a first mode (see FIG. 1), a second mode (see FIG. 3), and a third mode (see FIG. 5).

The first mode may be a state in which the cargo cover 1 is provided in a panel shape and covers an upper portion of the truck bed 2. The second mode may be a state in which the cargo cover 1 rotates to form an additional loading space S2. The third mode may be a state in which the cargo cover 1 is hinged to open an upper portion of the truck bed 2. The positions and dispositional relationships of the components to be described below are based on the first mode for convenience of explanation.

Referring to FIG. 1, the cargo cover 1 may cover the truck bed 2. The state illustrated in FIG. 1 may be a first mode of the cargo cover 1. That is, the first mode may be a state in which the cargo cover 1 is provided in a panel shape and covers an upper space of the truck bed 2. In the first mode, the cargo cover 1 may be provided in a panel shape as a whole. The cargo cover 1 may include, for example, a hinge fixing portion 100, a guide rail 200, a guide bracket 300, and a cover portion 400, any of, any combination of, or all of which may be in plural or may include plural components thereof.

The hinge fixing portion 100 may be provided on both sides of the truck bed 2 in a width direction. The guide rail 200 may be provided on both sides of the truck bed 2 in the width direction and extend in a length direction of the truck bed 2. A guide rail 200 may be inserted into the guide bracket 300. The guide bracket 300 may slide in the length direction along the guide rail 200. Both sides of the cover portion 400 in the width direction may be rotatably and detachably coupled to the hinge fixing portion 100. When the cover portion 400 is connected to the guide bracket 300, the cover portion 400 may slide along the guide rail 200. When the cover portion 400 is connected to the guide bracket 300 and slides, the cover portion 400 may be folded multiple times in the length direction. In other words, the cover portion 400 may be hinged in the length direction. The width direction may be an x-axis direction based on FIG. 1, the length direction may be a y-axis direction based on FIG. 1, and the thickness direction may be a z-axis direction based on FIG. 1.

Referring to FIGS. 2 and 3, the cargo cover 1 may be converted from a first mode to a second mode. The second mode may be a state in which the cargo cover 1 rotates and unfolds to form an additional loading space S2. Both sides of the cover portion 400 in a width direction may be rotatably provided in the hinge fixing portion 100. For example, both sides of the cover portion 400 in the width direction may be connected to the hinge fixing portion 100 and rotate inwardly and outwardly of the width direction. In the second mode state, when both sides of the cover portion 400 in the width direction rotate outwardly of the width direction about the hinge fixing portion 100 as an axis, an additional loading space S2 connected to the loading space S1 of the truck bed 2 may be formed on the inner side of the cover portion 400.

Referring to FIGS. 4 and 5, the cargo cover 1 may be converted from the first mode to a third mode. The third mode may be a state in which the cargo cover 1 is hinged and an upper portion of the truck bed 2 is opened. Both sides of the cover portion 400 in the width direction may be slidably provided on a guide rail 200. For example, both sides of the cover portion 400 in the width direction may be detachably coupled to the guide bracket 300, and when both sides of the cover portion 400 in the width direction are coupled to the guide bracket 300, the cover portion 400 may slide in the length direction along the guide rail 200. When the cover portion 400 slides along the guide rail 200, the cover portion 400 may be folded multiple times and hinged. Accordingly, the truck bed 2 may be opened.

As described above, the cargo cover 1 according to an embodiment of the present disclosure may form an additional loading space S2 as needed to expand the loading space S1 of the truck bed 2 (second mode) or open an upper portion of the truck bed 2 (third mode). Accordingly, an embodiment of the present disclosure can provide an advantage that allows the user to change a mode of the cargo cover 1 according to user convenience or truck bed usage needs.

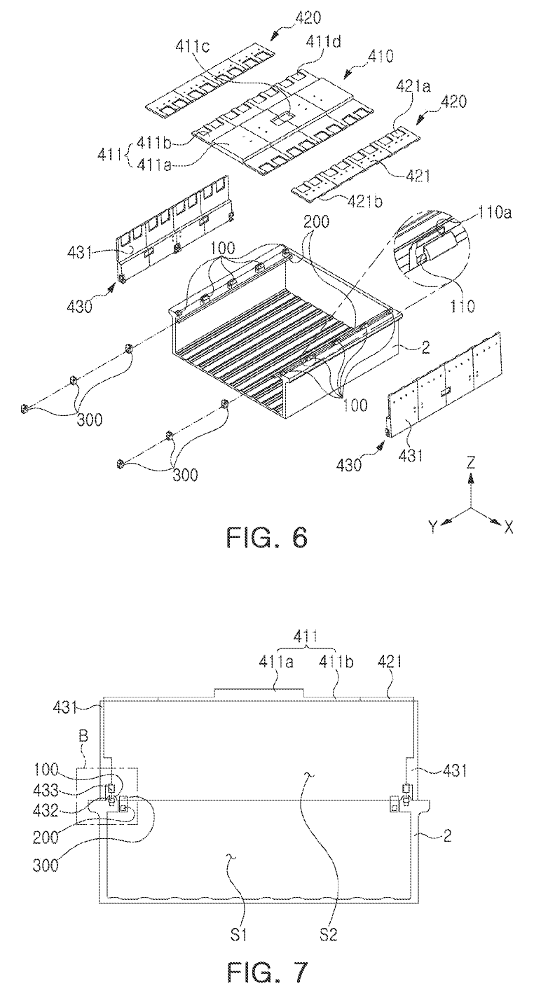

FIG. 6 is an exploded perspective view of a cargo cover according to an embodiment of the present disclosure. FIG. 7 is a front view of a cargo cover according to an embodiment of the present disclosure.

Referring to FIGS. 6 and 7, the cargo cover 1 according to an embodiment of the present disclosure may include a hinge fixing portion 100, a guide rail 200, a guide bracket 300, and a cover portion 400. The hinge fixing portion 100 may be provided on both sides of the truck bed 2 in a width direction. For example, a plurality of hinge fixing portions 100 may be provided on both sides thereof in the width direction spaced apart from each other by a set, selected, or predetermined distance. A side panel portion 430 of the cover portion 400 may be rotatably and detachably connected to the hinge fixing portion 100. For example, in the cover portion 400, both ends having the side panel portion 430 in the width direction may be rotatably and detachably coupled to the hinge fixing portion 100, based on FIG. 1. The hinge fixing portion 100 may be provided integrally with the truck bed 2 or may be manufactured as a separate member and coupled to the truck bed 2. When the hinge fixing portion 100 is manufactured as a separate member, the hinge fixing portion 100 may be detachably connected to the truck bed 2, for example.

A guide rail 200 may be provided on both sides of the truck bed 2 in the width direction. For example, one end or both ends of the guide rail 200 in a length direction may be coupled to the truck bed 2. In this case, the guide rail 200 may also be detachably coupled to the truck bed 2. A guide bracket 300 may be slidably provided on the guide rail 200. For example, the guide rail 200 may be inserted into a guide bracket 300, and the guide bracket 300 may slide in the length direction along the guide rail 200.

The guide rail 200 and the guide bracket 300 may be provided to guide the movement of the cover portion 400 when the cover portion 400 slides. For example, in the first mode state, both ends of the cover portion 400 in the width direction may be inserted into the guide bracket 300. When both ends of the cover portion 400 in the width direction are inserted into the guide bracket 300, the cover portion 400 may be separated from the hinge fixing portion 100. In this case, when an external force is applied to the cover portion 400 in the length direction, the cover portion 400 may be separated from the hinge fixing portion 100 and hinged at the same time, and may be slide by the guide rail 200 and the guide bracket 300. As a result, the cover portion 400 may be hinged and folded in the length direction and changed into a third mode.

The cover portion 400 may include, for example, a roof panel portion 410, a bridge panel portion 420, and a side panel portion 430, any of, any combination of, or all of which may be in plural or may include plural components thereof.

A roof panel portion 410 may be provided in a central portion of the cover portion 400 in the width direction. A bridge panel portion 420 may be rotatably provided on both ends of the roof panel portion 410 in the width direction. For example, a bridge panel portion 420 may be rotatably connected to an end of a roof panel portion 410 by a hinge. As the bridge panel portion 420 rotates, the bridge panel portion 420 may be mounted on one surface of the roof panel portion 410 (see FIG. 1) or separated from one side of the roof panel portion 410 (see FIG. 3). When the side panel portion 430 rotates inwardly and outwardly of the width direction, the roof panel portion 410 may rise or fall. When the roof panel portion 410 rises, an additional loading space S2 may be formed below the roof panel portion 410.

The roof panel portion 410 may be provided with a plurality of roof panels 411 which can be hingedably connected in the length direction. For example, a plurality of roof panels 411 may be hingedably connected by a hinge. The hinge may be coupled to a first roof panel hinge groove 411c formed on the roof panel 411 whose both ends can be disposed adjacent to each other. The number of roof panels 411 may be selected corresponding to the size of the truck bed 2. The roof panel 411 may be hinged and folded in the length direction when the cover portion 400 slides in the length direction (see FIG. 5).

The roof panel 411 may include, for example, a center part 411a and a fringe part 411b. The fringe part 411b may protrude outwardly of the width direction from a lower end of the center part 411a in the thickness direction. Therefore, a cross-section of the roof panel 411 across the width direction may be an inverted 'T' shape. An upper surface of the fringe part 411b in the thickness direction may be provided lower than an upper surface of the center part 411a in the thickness direction. Accordingly, a space may be provided above the fringe part 411b in which a bridge panel portion 420 can be disposed. When the side panel portion 430 rotates inwardly of the width direction, the bridge panel portion 420 may be mounted on an upper surface of the fringe part 411b in the thickness direction. When the side panel portion 430 rotates outwardly of the width direction, the bridge panel portion 420 may be separated from the upper surface of the fringe part 411b in the thickness direction. In the first mode state, the upper surface of the center part 411a in the thickness direction may be disposed on the same plane as the upper surface of the side panel portion 430 in the thickness direction. The fringe part 411b may be provided with a second roof panel hinge groove 411d. The bridge panel 421 may be provided with a first bridge panel hinge groove 421a. A bridge panel 421 may be rotatably coupled to the fringe part 411b, and for example, both ends of the hinge may be coupled to the first bridge panel hinge groove 421a and the second roof panel hinge groove 411d, thereby rotatably connecting the bridge panel 421 to the fringe part 411b.

A bridge panel portion 420 may be rotatably provided on both ends of the roof panel portion 410 in the width direction. The bridge panel portion 420 may be mounted on or separated from the upper surface of the roof panel portion 410 in the thickness direction as the bridge panel portion 420 rotates. In the first mode state, the bridge panel portion 420 may be provided between the side panel portion 430 and the roof panel portion 410. For example, at least a portion of the side panel portion 430 may be disposed above the bridge panel portion 420, and at least a portion of the roof panel portion 410 may be disposed below the bridge panel portion 420.

The bridge panel portion 420 may be provided with, for example, a plurality of bridge panels 421, which can be hingedably connected in the length direction. For example, a plurality of bridge panels 421 may be hingedably connected by a hinge. One side of the bridge panel 421 in the width direction may be rotatably coupled to an end of the side panel portion 430, and the other side of the bridge panel 421 in the width direction may be rotatably coupled to an end of the roof panel portion 410. When the side panel portion 430 rotates outwardly of the width direction, the bridge panel 421 may have an upper surface and a lower surface in the thickness direction exposed externally.

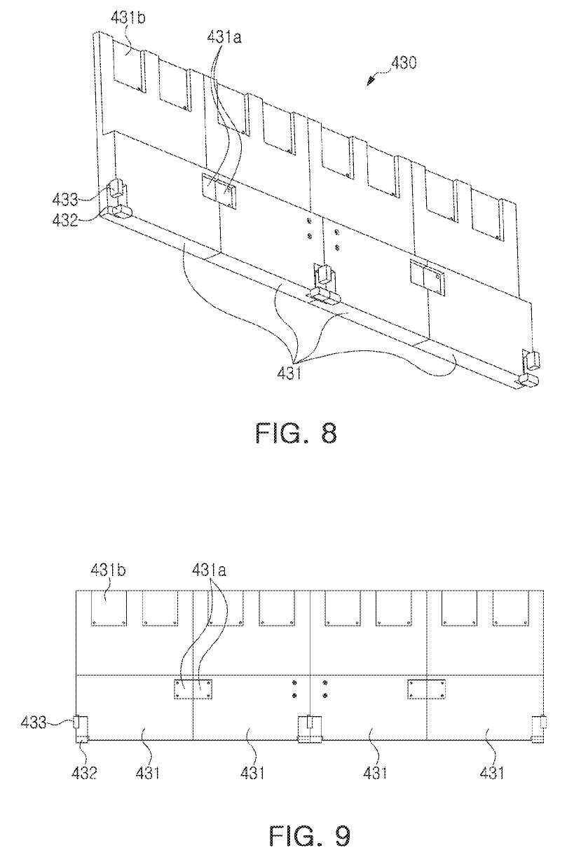

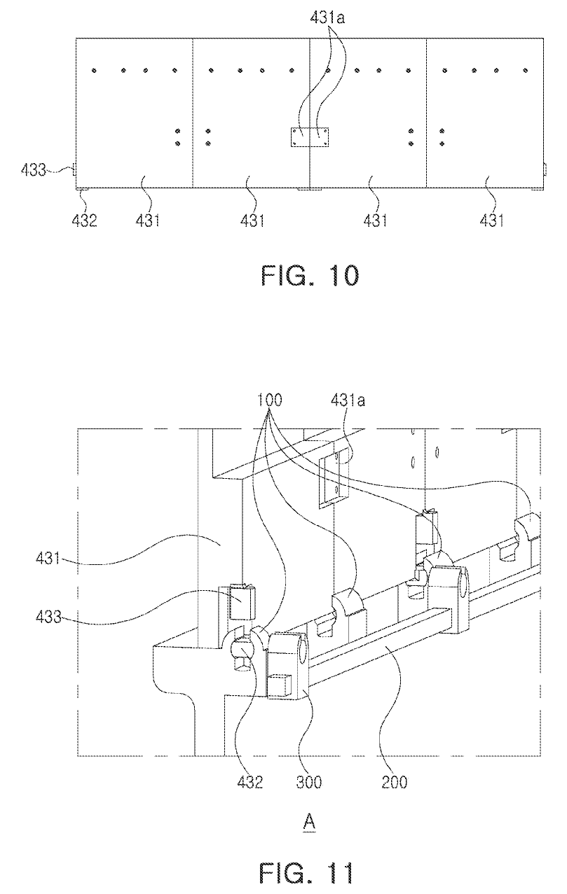

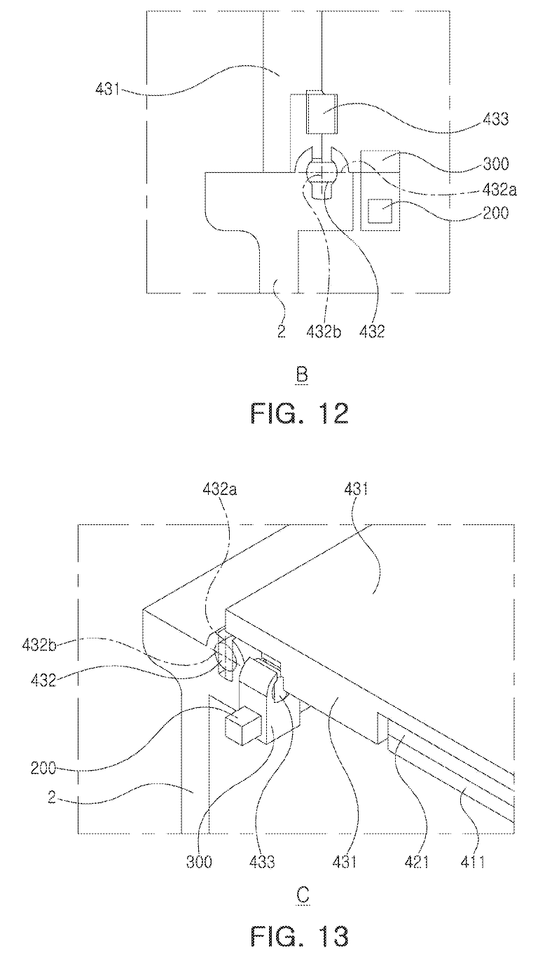

FIG. 8 is a perspective view of a side panel portion 430 according to an embodiment of the present disclosure. FIG. 9 is an inner side view of a side panel portion 430 in a width direction according to an embodiment of the present disclosure. FIG. 10 is an outer side view of a side panel portion 430 in a width direction according to an embodiment of the present disclosure. FIG. 11 is an enlarged view of part A of FIG. 3. FIG. 12 is an enlarged view of part B of FIG. 7. FIG. 13 is an enlarged view of part C of FIG. 1.

Referring to FIGS. 8-13, a side panel portion 430 may have one end rotatably connected to an outer end of the bridge panel portion 420 in a width direction, and the other end rotatably connected to the truck bed 2. For example, one end of the side panel portion 430 may be rotatably connected to the bridge panel portion 420 by a hinge. Both ends of the hinge may be coupled to a second side panel hinge groove 431b of the side panel portion 430 and a second bridge panel hinge groove 421b of the bridge panel 421. The side panel portion 430 may be provided on both sides of the roof panel portion 410 in the width direction.

As the side panel portion 430 rotates or slides, the state of the cover portion 400 may be changed to one of a first mode, a second mode, and a third mode.

When the side panel portion 430 rotates inwardly or outwardly of the width direction, the cargo cover 1 may be converted from the first mode to the second mode or from the second mode to the first mode. For example, in the first mode state, when the side panel portion 430 rotates outwardly of the width direction, in other words, when an end of the side panel portion 430 connected to the bridge panel portion 420 rotates outwardly of the width direction, the bridge panel portion 420 and the roof panel portion 410 connected to the side panel portion 430 may move upwardly of the thickness direction, the cargo cover 1 may be converted to the second mode. In this case, an additional loading space S2 may be formed inside the roof panel portion 410, the bridge panel portion 420, and the side panel portion 430. Conversely, when the end of the side panel portion 430 connected to the bridge panel portion 420 rotates inwardly of the width direction, the bridge panel portion 420 and the roof panel portion 410 connected to the side panel portion 430 move downwardly of the thickness direction, so that the cargo cover 1 may be converted from the second mode to the first mode. In describing with regard to the outward and inward rotation directions of the side panel portion 430 in the width direction, the outward rotation of the side panel portion 430 can be that the side panel portion 430 disposed on the left rotates counterclockwise and the side panel portion 430 disposed on the right rotates clockwise, based on the illustration of FIG. 7. The inward rotation of the side panel portion 430 can be that the side panel portion 430 disposed on the left rotates clockwise and the side panel portion 430 disposed on the right rotates counterclockwise, based on the illustration of FIG. 7.

When the side panel portion 430 slides in the length direction, the cargo cover 1 may be converted from the first mode to a third mode or from the third mode to the first mode. For example, when the side panel portion 430 slides in the length direction in the first mode, the side panel portion 430, the bridge panel portion 420, and the roof panel portion 410 may be hinged and folded in the length direction to open an upper portion of the truck bed 2, and the cargo cover 1 may be converted to the third mode.

For example, the side panel portion 430 may include a plurality of side panels 431 hingedably connected in the length direction. The plurality of side panels 431 may be hingedably connected by a hinge. The hinge may be coupled to a first side panel hinge coupling groove 431a formed in a side panel 431 whose both ends are disposed adjacent to each other. A side panel 431 may be connected to the side panel 431 disposed adjacent to each other on one side in the length direction so that an inner side surface thereof is rotatable, and a side panel 431 may be connected to the side panel disposed adjacent to each other on the other side in the length direction so that an outer side surface thereof is rotatable. A side panel 431 disposed on both ends in the length direction, when a side panel 431 disposed adjacent thereto is connected to the other side panel so that an inner side surface thereof can be rotatable, the side panel 431 disposed on both ends in the length direction may be connected to the other side panel disposed adjacent to each other so that an outer side surface thereof can be rotatable. Alternatively, the side panel 431 disposed on both ends in the length direction, when the side panel 431 disposed adjacent thereto is connected to the other side panel so that an outer side surface thereof can be rotatable, the side panel 431 disposed on both ends in the length direction may be connected to the other side panel disposed adjacent to each other so that an inner side surface thereof can be rotatable. Accordingly, when the side panel portion 430 slides in the length direction, the side panel 431 may be hinged in a zigzag shape. For example, when the side panel portion 430 of the cargo cover 1 slides inwardly of the length direction (in the -Y-axis direction based on FIG. 4) from the first mode state, a plurality of side panels 431 may be hinged in a zigzag shape and converted to a third mode state. Conversely, when the side panel portion 430 slides outwardly of the length direction (in the Y-axis direction based on FIG. 4) from the third mode state, the plurality of side panels 431 may be unfolded and converted to the first mode state.

The hinge fixing portion 100 may be provided with a through-hole 110 having an opening 110a formed on one side (see FIG. 6). A detachable shaft protrusion 432 may be provided at an end of the side panel 431 to be rotatably inserted into the through-hole 110 and to be detachable through the opening 110a depending on a rotation angle of the side panel 431. The detachable shaft protrusion 432 may include a virtual major axis 432a and minor axis 432b symmetrically dividing a cross-sectional shape of the detachable shaft protrusion 432 in the length direction. When the detachable shaft protrusion 432 rotates so that the major axis 432a is disposed toward the opening 110a, the side panel 431 may be separated from the hinge fixing portion 100. For example, when the cargo cover 1 is in the first mode state, the side panel 431 may be separated from the hinge fixing portion 100. When the detachable shaft protrusion 432 rotates so that the short axis 432b is disposed toward the opening 110a, the side panel 431 may not be separated from the hinge fixing portion 100. For example, when the cargo cover 1 is in the second mode state, the side panel 431 may not be separated from the hinge fixing portion 100. The side panel 431 may slide in the length direction when the side panel 431 is separated from the hinge fixing portion 100, and as the side panel 431 slides, the detachable shaft protrusion 432 of the side panel 431 may be separated from the hinge fixing portion 100.

A sliding protrusion 433 may be provided at an end of the side panel 431. The sliding protrusion 433 may be provided on the inner side in the width direction than the detachable shaft protrusion 432 based on FIG. 1. The sliding protrusion 433 may be inserted into or separated from the guide bracket 300 in response to a rotation angle of the side panel 431. For example, in the first mode, the sliding protrusion 433 may be inserted into the guide bracket 300, and the detachable shaft protrusion 432 may be separated from the hinge fixing portion 100. Alternatively, in the second mode, the sliding protrusion 433 may be separated from the guide bracket 300, and the detachable shaft protrusion 432 may be separated from the hinge fixing portion 100.

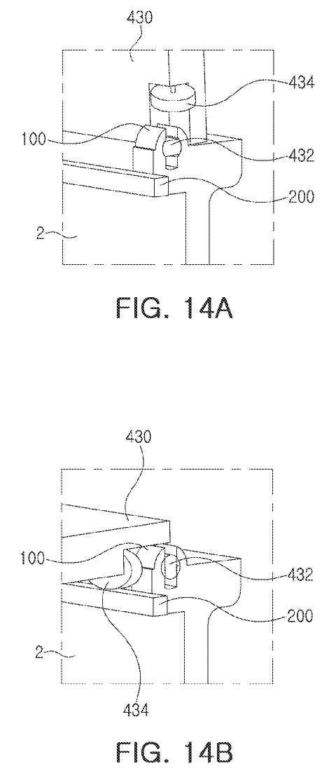

FIG. 14A is a perspective view of a second mode portion of a cargo cover according to another embodiment of the present disclosure, and FIG. 14B is a perspective view of a first mode portion of a cargo cover according to another embodiment of the present disclosure.

The embodiment illustrated in FIGS. 14A and 14B can be substantially the same as the embodiment illustrated in FIGS. 1-13 except that the guide bracket 300 can be omitted and instead a sliding roller 434 can be provided on the side panel 431. Therefore, a detailed description of the same configuration is omitted and replaced with the description provided above. Referring to FIGS. 14A and 14B, the side panel 431 may be provided with a sliding roller 434. The sliding roller 434 may be provided on the inner side in the width direction than a detachable shaft protrusion 432. The sliding roller 434 may be mounted on or separated from the guide rail 200 depending on the rotation angle of the side panel 431.

The cargo cover 1 according to an embodiment of the present disclosure described above may be converted to a first mode, a second mode, and a third mode, so that a user can change a structure of the cargo cover 1 according to user convenience.

According to above-mentioned embodiments of the present disclosure, a cargo cover can have the advantage of being converted to various structures as needed or desired by a user.

While example embodiments have been illustrated and described above, it can be apparent to those skilled in the art that modifications and variations could be made without departing from the scopes of the present disclosure as defined by the appended claims and equivalents thereof.

What is claimed is:

1. A cargo cover, comprising:
a hinge fixing portion configured to be disposed on both truck-bed sides of a truck bed of a vehicle in a width direction of the vehicle;
a guide rail configured to be disposed on the both truck-bed sides of the truck bed in the width direction and extending in a length direction of the truck bed; and
a cover portion, wherein both cover-portion sides of the cover portion in the width direction are rotatably and detachably coupled to the hinge fixing portion, and configured such that when the cover portion slides along the guide rail, the cover portion is separated from the hinge fixing portion and is hinged.

2. The cargo cover of claim 1, wherein the cargo cover is configured such that, when the both cover-portion sides of the cover portion in the width direction are rotatably coupled to the hinge fixing portion and when the both cover-portion sides of the cover portion in the width direction rotate outwardly of the width direction, respectively, an additional loading space connected to the truck bed is formed under the cover portion.

3. The cargo cover of claim 1, wherein the cargo cover is configured such that, when the cover portion slides in the length direction along the guide rail, the cover portion is hinged and folded such that the truck bed is opened.

4. The cargo cover of claim 1, wherein the cover portion comprises:
a roof panel portion;
bridge panel portions rotatably coupled on both roof-panel ends of the roof panel portion in a width direction, respectively; and
a side panel portion having a first side-panel-portion end rotatably connected to an outer bridge-panel-portion end of the bridge panel portion in the width direction and a second side-panel-portion end configured to be rotatably connected to the truck bed.

5. The cargo cover of claim 4, wherein the cargo cover is configured such that, when the first side-panel-portion end of the side panel portion rotates outwardly of the width direction, the bridge panel portion and the roof panel portion move upwardly of a thickness direction to form an additional loading space.

6. The cargo cover of claim 4, wherein the side panel portion includes a plurality of side panels hingedably connected to each other in a length direction,
wherein a first side panel of the side panels is hingedly connected to a second side panel of the side panels disposed adjacent to the first side panel on an inner side of the side panels so that an inner side surface thereof is rotatable, and
wherein the second side panel of the side panels is hingedly connected to a third side panel of the side panels disposed adjacent to the second side panel on an outer side of the side panels so that an outer side surface thereof is rotatable.

7. The cargo cover of claim 6, wherein the hinge fixing portion includes a through-hole with an opening on a top side thereof, and
wherein the side panels comprise a detachable shaft protrusion that can be rotatably inserted into the through-hole, and can be detachable through the opening depending on a rotation angle of the side panels, wherein the detachable shaft protrusion is disposed at the second side-panel-portion end of the side panels.

8. The cargo cover of claim 7, wherein the detachable shaft protrusion includes a virtual major axis and minor axis that symmetrically divide a cross-sectional shape of the detachable shaft protrusion, and configured such that when the major axis is disposed toward the opening, the side panels are detachable from the hinge fixing portion.

9. The cargo cover of claim 7, wherein the side panels are provided with a sliding roller configured to be mounted on or separated from the guide rail depending on a rotation angle of the side panels, and configured such that when the cover portion slides in the length direction, the sliding roller contacts the guide rail.

10. The cargo cover of claim 7, further comprising a guide bracket slidably coupled on the guide rail.

11. The cargo cover of claim 10, wherein the side panels comprise a sliding protrusion at the second side-panel-portion end of the side panels, and configured such that when the side panels rotate and the sliding protrusion can be inserted into the guide bracket and the detachable shaft can be detachable from the hinge fixing portion.

12. The cargo cover of claim 4, wherein the bridge panel portions are hingedably connected to each other in the length direction,
wherein the bridge panel portions comprise a bridge panel disposed between the side panel portion and the roof panel portion, and
wherein a first bridge-panel side of the bridge panel in a width direction is rotatably coupled to the first side-panel-portion end of the side panel portion, and a second bridge-panel side of the bridge panel in the width direction is rotatably coupled to a roof-panel end of the roof panel portion.

13. The cargo cover of claim 12, wherein the cargo cover is configured such that when the side panel portion rotates outwardly of the width direction, the bridge panel has upper and lower surfaces in a thickness direction exposed externally.

14. The cargo cover of claim 4, wherein the roof panel portion comprises a plurality of roof panels hingedably connected to each other in the length direction;
wherein each of the roof panels comprises:
a center part, and
a fringe part protruding outwardly of the width direction from a lower end of the center part in a thickness direction.

15. The cargo cover of claim 14, wherein a center-part upper surface of the center part in the thickness direction is disposed on a same plane as a side-panel upper surface of the side panel in the thickness direction.

16. The cargo cover of claim 4, wherein the cargo cover is configured such that when the side panel portion slides in the length direction, the side panel portion, the bridge panel portions, and the roof panel portion are hinged and folded in the length direction to open an upper portion of the truck bed.

17. A vehicle comprising:
a truck bed;
a cargo cover comprising:
a hinge fixing portion disposed on both truck-bed sides of the truck bed in a width direction of the vehicle,
a guide rail disposed on the both truck-bed sides of the truck bed in the width direction and extending in a length direction of the truck bed; and
a cover portion, wherein both cover-portion sides of the cover portion in the width direction are rotatably and detachably coupled to the hinge fixing portion, and configured such that when the cover portion slides along the guide rail, the cover portion is separated from the hinge fixing portion and is hinged.

18. A truck bed cargo cover comprising:
a hinge fixing portions configured to be disposed on both truck-bed sides of a truck bed of a vehicle in a width direction of the vehicle, wherein the hinge fixing portions are spaced apart from each other along a length direction of the vehicle, wherein each of the hinge fixing portions comprises a cylindrical hole extending in the length direction of the vehicle, wherein the cylindrical hole includes an opening on a top side thereof;
a guide rail configured to be disposed on the both truck-bed sides of the truck bed in the width direction and extending in the length direction of the vehicle;
a roof panel portion comprising roof panels distributed in the length direction and hingedly connected to each other;
two side panel portions configured to be disposed on the both truck-bed sides of the truck bed in the width direction, wherein each of the two side panel portions comprises side panels distributed in the length direction and hingedly connected to each other;
two bridge panel portions configured to be disposed on the both truck-bed sides of the truck bed in the width direction between the two side panel portions and the roof panel, respectively, wherein each of the two bridge panel portions comprises bridge panels distributed in the length direction, wherein each of the bridge panels includes an inner bridge-panel side and an outer bridge-panel side;
wherein a first side-panel side of the side panels is hingedly connected to the inner bridge-panel side of a corresponding bridge panel of the bridge panels, respectively;
wherein the outer bridge-panel side of a corresponding bridge panel of the bridge panels is hingedly coupled to a corresponding roof panel of the roof panels, respectively;
wherein on a second side-panel side of the side panels, each of the side panels comprises a detachable shaft protrusion having two cylindrical shaped sides opposite each other configured to fit with the cylindrical hole, wherein the detachable shaft protrusion has two flat sides opposite each other and separated by a width that is less than the opening on the top side of the cylindrical hole, such that the detachable shaft protrusion is configured to be detachable from the cylindrical hole or pivotably constrained by the cylindrical hole depending on a pivot angle of a respective side panel portion of the side panel portions relative to the hinge fixing portions;
wherein the truck bed cargo cover is configured to have a generally planar shape to cover the truck bed to provide a first covered cargo space below the truck bed cargo cover in the truck bed in a first mode, wherein the bridge panel portions are sandwiched between the side panel portions and the roof panel;
wherein the truck bed cargo cover is configured to have a generally inverted-U shape to cover the truck bed to provide a second covered cargo space below the truck bed cargo cover in the truck bed in a second mode, wherein the second covered cargo space is larger than the first covered cargo space, and wherein the bridge panel portions are unfolded and extending between the side panel portions and the roof panel; and
wherein the truck bed cargo cover is configured to have a zig-zag folded shape in the length direction to at least partially uncover the truck bed in a third mode, wherein the detachable shaft protrusion is detached from the cylindrical hole in the third mode.

19. The cargo cover of claim 18, wherein on a second side-panel side of the side panels, each of the side panels comprises a sliding roller configured to be mounted on or separated from the guide rail depending on the pivot angle of a respective side panel portion of the side panel portions relative to the hinge fixing portions, and configured such that the sliding roller contacts the guide rail during transitions between the first mode and the third mode.

20. The cargo cover of claim 18, further comprising a guide bracket slidably coupled on the guide rail; and
wherein on a second side-panel side of the side panels, each of the side panels comprises a sliding protrusion configured such that when the side panels rotate and the sliding protrusion can be inserted into the guide bracket and the detachable shaft can be detachable from the hinge fixing portion during transitions between the first mode and the second mode.
